(19) United States
(12) Patent Application Publication
(10) Pub. No.: US 2020/0283552 A1
(43) Pub. Date: Sep. 10, 2020

(54) HYDROPHILIC SURFACTANT ADDITIVE CONCENTRATES AND COMPOUNDS

(71) Applicant: PolyOne Corporation, Avon Lake, OH (US)

(72) Inventor: Gary VERNON, Sugar Hill, GA (US)

(73) Assignee: PolyOne Corporation, Avon Lake, OH (US)

(21) Appl. No.: 16/325,715

(22) PCT Filed: Aug. 14, 2017
(86) PCT No.: PCT/US2017/046811

§ 371 Date: Feb. 14, 2019

Related U.S. Application Data
(60) Provisional application No. 62/375,410, filed on Aug. 15, 2016.

(51) Int. Cl. C08F 110/02; C08K 5/20; C08K 3/36; C08L 23/06

(52) U.S. Cl. CPC C08F 110/02; C08K 5/20; C08K 3/36; C08L 2207/04; C08F 2500/08; C08L 2310/00; C08L 23/06

(57) ABSTRACT

Three different agents are used to improve hydrophilic surface active efficacy of hydrophilic surface active masterbatches, the polymer compounds these hydrophilic surface active masterbatches are let down into, and the articles made therefrom.

### CLAIM OF PRIORITY

This application claims priority from U.S. Provisional Patent Application Ser. No. 62/375,410 bearing Attorney Docket Number 12016040 and filed on Aug. 15, 2016, which is incorporated by reference.

### FIELD OF THE INVENTION

This invention relates to additives for polymeric compounds to improve properties of such polymeric compounds.

### BACKGROUND OF THE INVENTION

Plastic has taken the place of other materials in a variety of industries. Plastic has replaced glass to minimize breakage, reduce weight, and reduce energy consumed in manufacturing and transport. In other industries, plastic has replaced metal to minimize corrosion, reduce weight, and provide color-in-bulk products.

To meet the many applications for plastics, the world in the past seventy years has seen a revolution in material science arising from the combination of a thermoplastic resin and one or more functional additives to provide specific properties to the resin.

In some situations, hydrophilic surface properties have become particularly desirable in plastics used for many applications, including medical equipment, food processing, packaging, healthcare products, and consumer and household items.

### SUMMARY OF THE INVENTION

Hydrophilic surface active agents (also called hydrophilic surfactants) can be supplied in the form of thermoplastic concentrates formulated to give the final part hydrophilic surface properties. These concentrates (also called “masterbatches”), upon blending into the thermoplastic resin, allow the plastic article to exhibit hydrophilic surface properties, often measured by a water contact angle test in which the lower the angle the more compatible water is to wet the surface of the plastic article. The masterbatches are supplied in a pelletized, non-dusting form tailored to a specific resin system. A typical dilution or “let-down” ratio for a masterbatch ranges from about 100:1 (1%) to about 10:1 (10%), and preferably a range of 25:1 (4%) to about 12.5:1 (8%).

Typical applications for plastic articles with hydrophilic surfaces include packaging; consumer products, particularly personal care items; medical devices; and any other plastic article or apparatus in which repelling of water from the surface of the plastic article or apparatus is not required.

The present invention solves the problem in the art by enhancing the hydrophilic surface properties of the plastic article or apparatus.

One embodiment of the invention is a hydrophilic surface active masterbatch for thermoplastic compounds, comprising a polymer carrier, an anti-fog agent, a slip agent, a matting agent, and optionally other additives.

Another embodiment of the invention is a hydrophilic surface active compound comprising the masterbatch and a base polymer resin.

Another embodiment of the invention is the hydrophilic surface active compound in the shape of a molded plastic article, an extruded plastic article, a calendered plastic article, a thermoformed plastic article, or a 3D printed plastic article.

Another aspect of the invention is a method of using the hydrophilic surface active compound by shaping the compound into an article designed to have hydrophilic surface active properties. The shaping can be done by extruding, molding, calendering, additive manufacturing, 3D printing or thermoforming.

Other features will become apparent from a description of the embodiments of the invention.

### EMBODIMENTS OF THE INVENTION

Polymer Resin

Any polymer resin is a candidate for use in the present invention as a carrier polymer, base polymer resin or both. Preferably, the carrier polymer is selected according to its miscibility in the base polymer resin for improved dispersion of the masterbatch in the compound.

Non-limiting examples of large volume commercial polymer resins include polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

Published literature exists to identify many commercial species of these categories of thermoplastic resins. Non-limiting examples of specific commercial thermoplastic resins include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN).

Presently, low density polyethylene (LDPE) is preferred as the carrier, desirably in powder form, and having a melt flow index of about 8.

Anti-Fogging Agent

Any hydrophilic agent known by persons having skill in the art is a candidate for use in the present invention. Presently CHEMSTAT® AF-1879 polymer additive, a proprietary material from PCC Chemax of Piedmont, S.C. is preferred because the additive is known to be useful for anti-fogging and anti-static properties when used in polymer compounds made into plastic articles and apparatus.

Slip Agent

Any additive that resides or migrates (i.e. “blooms”) to the surface of a polymer to bring lubricating properties can be a candidate for use in the embodiments. These additives are often called “slip additives.” Typical slip additives are, for example, oleamide, erucamide, stearamide, behenamide, oleyl palmitamide, stearyl erucamide, ethylene bis-oleamide, and N,N′-Ethylene Bis(Stearamide) (EBS), polyol partial esters; and hydrogenated soybean oil.

Erucamide (CAS No. 112-84-5) is presently preferred as the slip agent. Erucamide is commercially available from a number of suppliers.

Matting Agent

Any material which provides a matt surface to a plastic article is a candidate for use in the embodiments.

Presently preferred is Gasil® HP39 matting agent made of large particle silica gel for use in high solids, low volatile organic chemical, pigmented water based coatings.

Optional Colorant

A colorant can be a pigment, a dye, a combination of pigments, a combination of dyes, a combination of pigments and dye, a combination of pigment and dyes, or a combination of pigments and dyes. The choice of colorants depends on the ultimate color desired by the designer for the plastic article.

The science of color is well known to those skilled in the art. Without undue experimentation, one can use color matching techniques to identify a particular location in spherical color space. For example, one skilled in the art can use the teachings of PCT Patent Publication WO/2004/095319 to digitally map color space using specific polymer carriers and colorants as raw material ingredients. Alternatively, one can make small samples called plaques for visual review.

Colorants are commercially available from a number of sources well known to those skilled in the art. Commercially available pigments are well known to those skilled in the art and include organic and inorganic colorant chemistries. Commercially available dyes are well known to those skilled in the art and include all organic chemistries. Commercial sources for pigments and dyes include multinational companies such as BASF, Bayer, Color-Chem International, Sun Chemical, and Zhuhai Skyhigh Chemicals.

Optional Functional Additives

Optionally, conventional plastics additives can be added to either the hydrophilic surface active masterbatch or the let-down polymer compound of the invention, in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (elsevier.com website), can select from many different types of additives for inclusion into the compounds of the present invention.

Non-limiting examples of optional additives include heat stabilizers, char formers, adhesion promoters; biocides; anti-fogging agents; anti-static agents; anti-oxidants; bonding, blowing and foaming agents; dispersants; fillers and extenders; smoke suppressants; impact modifiers; initiators; lubricants; micas; pigments, colorants and dyes; plasticizers; processing aids; release agents; silanes, titanates and zirconates; slip agents, anti-blocking agents; stearates; ultraviolet light absorbers; viscosity regulators; waxes; catalyst deactivators, and combinations of them.

Generally, minor amounts of such additives provide improvement of performance to the masterbatch or polymer compound during processing with the other ingredients in the polymer resin or in performance of the polymeric molded article after manufacturing. One skilled in the art without undue experimentation can determine the appropriate concentration.

Table 1 shows acceptable, desirable, and preferable ranges of ingredients useful in the masterbatch of the present invention, all expressed in weight percent (wt. %) of the masterbatch. The masterbatch can comprise, consist essentially of, or consist of these ingredients.

TABLE 1

| | Acceptable | Desirable | Preferred |
|---|---|---|---|
| Ingredient (Wt. %) | Range | Range | Range |
| Polymer Carrier | 66-87 | 78-82 | 72-80 |
| Anti-fogging Agent | 10-20 | 13-17 | 14-16 |
| Slip Agent | 2-8 | 3-7 | 4-6 |
| Matting Agent | 1-5 | 2-4 | 2-3 |
| Optional Colorant | 0-80 | 0-75 | 0-65 |
| Optional Functional | 0-65 | 0-55 | 0-50 |
| Additives | | | |

The masterbatch can be “let-down” into a base polymer resin according to a ratio of base polymer resin to masterbatch ranging from about 100:1 (1%) to about 10:1 (10%), and preferably 25:1 (4%) to about 12.5:1 (8%).

Processing of the Masterbatch

One can prepare the masterbatch using continuous or batch techniques, using extruders or mixers, respectively. The mixing equipment can be any suitable equipment already used in the art of mixing highly concentrated solids. For example, such equipment includes high speed Henschel mixers, ribbon blenders, shakers, extruders and the like.

Mixing in a continuous process typically occurs in an extruder that is elevated to a temperature that is sufficient to melt the polymer carrier with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion, molding, or calendering into polymeric articles.

Alternatively, mixing in a batch process typically occurs in a Banbury or other batch mixer that is also elevated to a temperature that is sufficient to melt the polymer matrix to permit addition of the solid ingredient additives. The mixing speeds range from 60 to 1000 rpm. Also, the output from the mixer is chopped into smaller sizes for later extrusion, molding, or calendering into polymeric articles.

The concentration of hydrophilic surface active agent into the polymer carrier is significant because of the relative cost of the hydrophilic surface active agent ingredient(s), and the need for the hydrophilic surface active agent to consistently and precisely mix and disperse into the polymer carrier and then to consistently and precisely dilute into the base polymer resin and other compound ingredients during “let-down”. Let-down ratios depend on the hydrophilic surface active activity required for the final article.

Presently preferred is processing of the anti-fog agent, the slip agent, and the matting agent as a pre-blend before introduction to the melt mixing vessel of the LDPE carrier.

Subsequent Processing of the Compound and Polymeric Article

Let-down of the masterbatch of the invention into a polymer compound may be done during subsequent steps of reshaping by extrusion, molding, or calendering. Processing begins with melt-mixing the masterbatch with the base polymer resin followed by reshaping by extrusion, molding, or calendering, followed by natural or accelerated cooling to form the final plastic article desired.

In the case of molding, particularly injection molding, the reshaping step includes pressurized injecting, holding, and cooling steps before the plastic article is ejected, the cycle of which the time is being measured to determine cycle time. More specifically, the reshaping step comprises four substeps of (1) injecting the compound into a mold; (2) holding the compound in the mold to form the plastic article in the shape of the mold; (3) cooling the plastic article to permit the plastic article to be released from the mold while retaining shape of the mold; and (4) ejecting the final plastic article.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (williamandrew.com), one can make articles of any conceivable shape and appearance using compounds of the present invention.

### Usefulness of the Invention

The hydrophilic surface active masterbatches of the present invention can be let-down into polymers resins, with other ingredients, to make molded, calendered, extruded, thermoformed, or 3D printed hydrophilic surface active articles.

Hydrophilic surface active characteristics are desirable for articles used in many applications, including; communication equipment (stationary, mobile, and handheld, including telephones, headsets, handsets, intercoms, earphones, and microphones and other input/output devices); medical and healthcare products (wheelchairs, beds, testing equipment, packaging, gloves, medical equipment, catheters, protective covers, and medical tubing); household items (including shower curtains, containers, handles, sponges); and packaging (food and beverage, cosmetic, detergents and cleaners, personal care, pharmaceutical and wellness).

### EXAMPLE

An embodiment of the invention was made from 15 weight percent Chemstat® AF-1879 proprietary anti-fog agent, 5 weight percent erucamide powder slip agent, and 2.5 weight percent of Gasil® HP39 large particle silica gel matting agent blended together in a heated vessel and well mixed before introduction of 77.5 weight of 8 melt flow index LDPE polymer resin in powder form with mixing and melting to a temperature about the melting point of the polymer resin. After complete melt mixing, the hydrophilic surface active masterbatch was ready for let-down into a polymer and other additives, as identified above.

The invention is not limited to the above embodiments. The claims follow.

1. A hydrophilic surface active masterbatch for thermoplastic compounds, comprising:
(a) a polymer carrier
(b) an anti-fog agent
(c) a slip agent
(d) a matting agent, and
(e) optionally other additives.

2. The masterbatch of claim 1, wherein the polymer carrier is selected from the group consisting of polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

3. The masterbatch of claim 1, wherein other additives are selected from the group consisting of anti-blocking agents; adhesion promoters; fungicides; mildewcides; anti-fogging agents; bonding, blowing and foaming agents; dispersants; fillers and extenders; fire and flame retardants and smoke suppressants; impact modifiers; initiators; lubricants; micas; pigments, colorants and dyes; plasticizers; processing aids; other slip or release agents; other anti-static agents; silanes, titanates and zirconates; stabilizers; stearates; ultraviolet light absorbers; viscosity regulators; waxes; and combinations of them.

4. The masterbatch of claim 1, wherein ingredients by weight percent of the masterbatch are:

| | |
|---|---|
| Polymer Carrier | 66-87 |
| Anti-fogging Agent | 10-20 |
| Slip Agent | 2-8 |
| Matting Agent | 1-5 |
| Optional Colorant | 0-80 |
| Optional Functional Additives | 0-65. |

5. A hydrophilic surface active compound comprising the masterbatch of claim 1 and a base polymer resin.

6. The hydrophilic surface active compound of claim 5, wherein the base polymer resin is selected from the group consisting of polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

7. The hydrophilic surface active compound of claim 5, further comprising additives selected from the group consisting of anti-blocking agents; adhesion promoters; fungicides; mildewcides; anti-fogging agents; bonding, blowing and foaming agents; dispersants; fillers and extenders; fire and flame retardants and smoke suppressants; impact modifiers; initiators; lubricants; micas; pigments, colorants and dyes; plasticizers; processing aids; other slip or release agents; other anti-static agents; silanes, titanates and zirconates; stabilizers; stearates; ultraviolet light absorbers; viscosity regulators; waxes; and combinations of them.

8. The hydrophilic surface active compound of claim 5, wherein the amount of the masterbatch let down into base resin ranges from 1% to 10% of the weight percent of the compound.

9. The hydrophilic surface active compound of claim 5, in the shape of a molded plastic article, an extruded plastic article, a calendered plastic article, a thermoformed plastic article, or a 3D printed plastic article.

10. A molded article made from the hydrophilic surface active compound of claim 5.

11. An extruded article made from the hydrophilic surface active compound of claim 5.

12. A calendered article made from hydrophilic surface active compound of claim 5.

13. A thermoformed article made from the hydrophilic surface active compound of claim 5.

14. A method of using the hydrophilic surface active compound of claim 5, comprising the step of shaping the compound into an article designed to have hydrophilic surface active properties.

15. The method of claim 14, wherein the shaping comprises extruding, molding, calendering, additive manufacturing, 3D printing or thermoforming.
